(19) United States
(12) Patent Application Publication
(10) Pub. No.: US 2003/0009682 A1
(43) Pub. Date: Jan. 9, 2003

(54) Method of personalized communication with respect to various computer applications, and a corresponding program product

(75) Inventors: Iain Wallace, Paris (FR); Bertrand Levavasseur, Feucherolles (FR); Dominique Pavlin, Verneuil/Seine (FR); Christophe Bouilhol, Chatou (FR)

Correspondence Address: YOUNG & THOMPSON, 745 SOUTH 23RD STREET 2ND FLOOR, ARLINGTON, VA, 22202

(73) Assignee: NETQUARTZ, NANTERRE (FR)

(21) Appl. No.: 10/186,731

(22) Filed: Jul. 2, 2002

(30) Foreign Application Priority Data
Jul. 3, 2001 (FR) 01 08810

(51) Int. Cl. H04L 9/32

(52) U.S. Cl. 713/193

(57) ABSTRACT

The invention relates to a personalized communications method associated with various computer applications, and to a corresponding program product. The method comprises the steps of: associating the various applications with a common interface adapted to be configured to contain identity data for the common interface, in verifying during installation of each application on the computer whether the common interface is already present, in automatically linking the application with the common interface when the common interface is already installed, in establishing a connection between the common interface and a server on launching an application, and in transmitting to the server at least part of the identity data of the common interface.

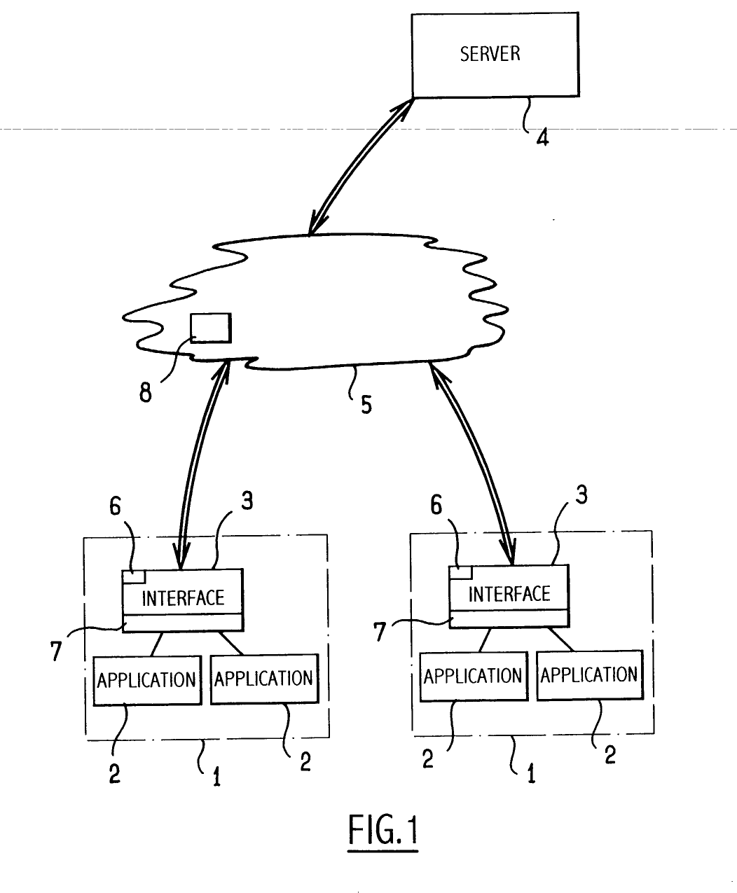

The present invention relates to a method of personalized communication relating to various computer applications installed on a user computer.

### BACKGROUND OF THE INVENTION

In order to encourage the spread of computer applications, it is necessary to communicate with users in personalized manner as a function of their habits so as to make such users more responsive to the messages which are sent to them. It is also useful to make applications available to users free of charge in order to enable users to try them out. As a general rule, making an application available to a user in this way does indeed enable the user to verify whether the application in question is of interest, but it does not give the publisher any indication concerning the number of trial versions that have been used or about any problems that might have been encountered.

Document WO 00/49483 discloses a method of establishing a link between a user and a publisher, the method comprising the steps of automatically setting up a connection with a remote server each time an application is put into operation and exchanging information with the server about the application in question. That method serves to establish a link between the publisher and the user concerning each application taken separately, but it does not enable the various centers of interest of any one user to be cross-correlated, nor does it enable the difficulties encountered by the user to be analyzed depending on the application in question, particularly since a single user can, either inadvertently or intentionally, provide different user identities in respect of different applications.

### OBJECTS AND SUMMARY OF THE INVENTION

An object of the invention is to propose a personalized communications method relating to various computer applications on the same user computer.

The invention provides a method comprising the steps of: associating the various applications with a common interface adapted to be configured to contain identity data for the common interface, in verifying during installation of each application on the computer whether the common interface is already present, in automatically linking the application with the common interface when the common interface is already installed, in establishing a connection between the common interface and a server on launching an application, and in transmitting to the server at least part of the identity data of the common interface.

This makes it possible in the server to monitor the use made of the various applications by a single user and to keep statistics of the use undertaken by different users in order to extract information useful in disseminating targets messages corresponding to a destination user profile for such messages, in particular in order to send messages to the user that are personalized with respect to the various applications held by the user, for example technical advice concerning the combined use of two applications or advertising messages concerning products that could usefully be added in to the combination of applications already installed.

In addition, for a user who has already installed a first application associated with a common interface, installing a new application is made easier by the fact that it is not necessary to input the identity data already associated with the common interface.

Furthermore, the single identity in the common interface prevents a dishonest user from simultaneously using two applications while pretending to have different identities on them so as to avoid corresponding limits on use applicable to those applications.

In an advantageous version of the invention, the identity data is not modifiable other than during first installation of the common interface.

Thus, the identity of the common interface can be modified only by uninstalling all of the applications so that a dishonest user seeking to overcome limits on free uses of one of the applications will need to uninstall all of the other applications which would give rise to operations that are lengthy and time consuming and would cause that user to lose any rights that might already have been acquired on certain applications, in particular in the event of paid-for downloading of one of those applications.

The method preferably includes a step performed in the server of checking the application user rights and of authorizing or preventing the launching of an application as a function of such verification.

Furthermore, in order to manage personalized messages, it is generally necessary to maintain files storing information relating to each particular user. Nevertheless, maintaining such files is cumbersome and is also subjected to ever stricter regulations concerning preserving the freedoms of users.

In an implementation of the invention, steps are also provided of associating the common interface installed on a user computer with selection data specific to the user and to the applications associated with said common interface, in sending from the server various messages relating respectively to the various items of selection data, and in each user computer automatically selecting those messages that correspond to the selection data contained in its common interface whenever an associated application is launched or is in operation. The files held by the server are then restricted to the information needed for controlling the access of various users to the corresponding applications, so personal information remains strictly confidential.

The method preferably also comprises the step of using the common interface to establish a link between the server and a bulletin board.

The invention also provides a program product stored on a storage medium that is readable by a computer and that is suitable for implementing the method of the invention.

### BRIEF DESCRIPTION OF THE DRAWING

Other characteristics and advantages of the invention appear on reading the following description of a particular and non-limiting implementation as described below with reference to the sole accompanying FIGURE which is a block diagram representing means for implementing the method of the invention.

### MORE DETAILED DESCRIPTION

With reference to the FIGURE, the system implementing the method of the invention comprises user computers 1 each having various applications 2 installed therein, which applications are associated in each computer with a common interface. The common interfaces 3 further comprise means enabling a connection to be established with a server 4 over a network 5.

In accordance with the invention, each application 2 is provided with means for installing the common interface 3. When a first application is installed on a user computer 1, the common interface 3 is installed initially and identity data 6 is associated therewith. The identity data 6 is stored in the user computer 1 and, other than during said first installation, cannot be modified without running the risk of losing user rights in respect of applications that have already been installed. Thereafter, the application is installed and is automatically associated with the common interface 3.

On each occasion an application is installed, a check is performed to determine whether the common interface 3 is already present on the computer. If it has already been installed, then the new application is automatically connected to the common interface without enabling a new identity to be given to the interface. In order to reduce the risk of fraud, the identity data of the interface may comprise either data input by the user during installation or data inserted automatically by the installation program such as a serial number of the application in the event of downloading, or indeed a combination of input data and data that is downloaded automatically from the server. To this end, the program for installing the interface and the associated application preferably has means for establishing communication with the server 4 at the time of installation.

The common interface 3 is also adapted for being associated with selection data 7 specific to the user and to the applications associated with the common interface. The selection data 7 can be of various kinds. By way of example, it can relate to the way in which the application was acquired (downloading, CD-ROM, . . . ) or to the site at which the application was acquired, or indeed to the experience of the user. The selection data 7 can also comprise data relating to the use made of each application, and in particular the frequency with which each application is used, the functions within each application that are used, the mistakes made when using it . . . , which data can be acquired either automatically from the medium that enabled the application to be installed or by the user keying in data in response to messages that are displayed automatically by the interface under certain circumstances, or at the initiative of the user, with the handling of the interface by the user possibly being made easier by implementing standard icons for the various applications. The selection data can have further data associated therewith by the server in association with data input by the user. For example, when the user inputs the serial number mentioned on the CD-ROM, the server 4 can establish a link with the way in which a CD-ROM carrying such a serial number is distributed (at a fair, by correspondence, details of a retail outlet), and can add to the selection data of the common interface in corresponding manner. The selection data can be stored either on the user computer or in the server 4 or partly in the user computer and partly in the server, with selection data of a less personal nature being stored in the server, for example, while data that is more personal being retained on the user computer.

Each time an application is launched, the common interface 3 is automatically activated and a connection is established with the server. This connection is preferably used initially to verify that the user computer is authorized to access the application in question. Because of the unique identity for the user in the common interface, an application cannot be transferred to another user except in association with the other applications that are associated with the same interface, and it cannot be integrated in an interface containing some other identity. As a result, it is not possible to transfer an application to a third party without the original user losing rights held over other applications. For this purpose, the link with the server 4 can be used to implement the secure method of use as described in document WO 00/49483.

In a preferred implementation, the common interface 3 has means enabling a window to be opened in which messages coming from the server 4 are displayed. These messages naturally contain information having a direct bearing on the identity of the interface, for example in order to inform the user that certain user rights have expired. These messages also include messages relating to selection data associated with the common interface, for example an indication that the retailer from whom the application was purchased is presently running a promotion on other applications, or indeed the dates of the next version of the fair at which an application was acquired.

The invention also provides for the server 3 sending various messages that correspond respectively with various items of selection data, for example by associating each broadcast message with a code that corresponds to selection data matching the message. The various messages are then broadcast to all of the common interfaces, and those messages which contain the selection data of the interface in question are then automatically selected in each common interface 3. For example, when the interface 3 contains data relating to the location of the user computer, the server issues various messages, each associated with a particular location, and the interface selects those messages that relate to local events corresponding to its own location data. It is also possible to store in association with the interface 3 information relating to the nature of the applications installed on the computer in question and to display selectively information that relates to said applications, whether that information is in the form of advice for users or advertising messages concerning applications that could usefully be added to the applications already installed. Messages broadcast in this way can also relate to the difficulties in handling the application that the user has encountered, with such messages being selected on the basis of the selection data associated with the interface 3 during such handling. The various messages can be subdivided into different categories (product information, technical support, . . . ) and can be broadcast by the server 4 either automatically or at the request of a user clicking on a corresponding icon, with automatic selection of messages relating to selection data being performed in both cases by the common interface 3. The messages can also relate to products that can be purchased on line. Under such circumstances, the display window of the interface preferably includes a button giving access to the point of sale that is immediately accessible in the server over the connection that has already been established therewith. It is possible in the same manner to provide the interface window with a button giving direct access to technical support.

When the user has included in the configuration data the address of a bulletin board 8 to which the user computer can have access, it is also possible to cause the server to send messages which, when selected by the interface 3, are sent to the e-mail inbox of the bulletin board 8, and the presence of such messages is indicated to the user via the display window of the interface 3. The term “bulletin board” is used in the meaning of the invention not only to designate a bulletin board located in an external network, such as the Internet, but also a letter box located in the user computer and operating under the control of the interface so that data transfers can take place therethrough.

The invention also provides a program product enabling the method of the invention to be implemented.

To this end, the program product is stored on a storage medium that can be read by a computer, and it contains at least one application and the associated common interface together with means for installing said application and the associated common interface on a computer, said installation means comprising means for verifying the presence of the common interface and means for automatically establishing a connection between the application and the common interface in the event of the interface already being installed, the program product also containing means enabling the common interface 3 to be configured so as to introduce identity data into the interface and means enabling a connection to be established between the common interface 3 and the server 4 prior to launching an application and for transmitting the interface identity data to the server 4 together with means for storing in the common interface 3 the selection data specific to the applications associated with said common interface and for automatically selecting amongst the messages received from the server 4 those messages which correspond to the selection data of each application, whenever that application is launched or is running.

Naturally, the invention is not limited to the information described and various implementations can be devised without going beyond the ambit of the invention as defined by the claims.

In particular, although the invention is described with reference to a particular implementation in which identity data associated with the common interface cannot be modified other than during initial installation of the common interface, the method of the invention could also be implemented while allowing identity data to be modified but while automatically verifying the access authorizations of all of the applications associated with the common interface on each connection to the server 4 and definitively interrupting operation of any application which is not authorized in association with the current identity data. A user who modifies the identity data to take advantage of a new trial version that has already been used under an earlier identity thus immediately loses any rights previously acquired over all of the applications associated with the common interface.

Although the invention is described in association with a system that involves making a connection with a server, the portion of the method of the invention involving making use secure can be implemented in a personal computer that is not connected to a network, in which case the interface 3 contains means enabling the parameters authorizing access to an application to be stored so that these parameters can be modified only by installing an authorized version of an application.

Although the invention is described with reference to messages being selected by the interface, the common interface can also be used for transmitting to the server all of the information that is needed for issuing targeted messages that are addressed solely to particular addressees.

1./ A personalized communications method associated with various computer applications on a user computer, the method comprising the steps consisting in: associating the various applications with a common interface adapted to be configured to contain identity data for the common interface, in verifying during installation of each application on the computer whether the common interface is already present, in automatically linking the application with the common interface when the common interface is already installed, in establishing a connection between the common interface and a server on launching an application, and in transmitting to the server at least part of the identity data of the common interface.

2/ A method according to claim 1, including the step performed in the server of checking rights to use an application and of authorizing or forbidding launching of the application as a function of said check.

3/ A method according to claim 1, wherein the identity data is not modifiable except during initial installation of the common interface.

4/ A method according to claim 1, comprising the steps of storing selection data in the user computer, said selection data being associated with the common interface, of sending various messages from the server associated respectively with different items of selection data, and of automatically selecting in each user computer those messages which correspond to selection data associated with the common interface whenever an application associated with the common interface is launched or operated.

5/ A method according to claim 4, including the step of establishing a link between the server and a bulletin board via the common interface.

6/ A program product stored on a storage medium readable by a computer, the product comprising at least one application associated with a common interface and means for installing said application and the associated common interface on a computer, said installation means including means for verifying whether the common interface is present and means for automatically establishing a connection between the application and the common interface when said interface is already installed, the program product further comprising means enabling a common interface to be configured to enable identity data to be input into the common interface and means enabling a connection to be established between the common interface and a server when launching an application and for transmitting to the server at least a part of the identity data of the common interface.

7/ A program product according to claim 6, comprising means for introducing a modification to the identity data other than during first installation of the common interface.

8/ A program product according to claim 6, comprising means for storing selection data associated with the common interface in correspondence with the common interface, and for automatically selecting amongst messages received from the server those messages which correspond to the selection data of each application when the application is launched or is running.
